(19) United States
(12) Patent Application Publication
(10) Pub. No.: US 2013/0162385 A1
(43) Pub. Date: Jun. 27, 2013

(54) COIL PARTS AND METHOD OF MANUFACTURING THE SAME

(71) Applicant: c/o Samsung Electro-Mechanics Co., LTD., Gyeonggi-do (KR)

(72) Inventors: Jeong Bok Kwak, Gyeonggi-do (KR); Sang Moon Lee, Seoul (KR); Young Seuck Yoo, Seoul (KR); Sung Kwon WI, Seoul (KR); Yong Suk Kim, Gyeonggi-do (KR)

(73) Assignee: C/O SAMSUNG ELECTRO-MECHANICS CO., LTD., Gyeonggi-do (KR)

(21) Appl. No.: 13/707,258

(22) Filed: Dec. 6, 2012

(30) Foreign Application Priority Data
Dec. 22, 2011 (KR) 10-2011-0140413

(51) Int. Cl. H01F 17/00; H01F 41/00

(52) U.S. Cl. CPC H01F 17/0013; H01F 41/00
USPC 336/200; 29/605

(57) ABSTRACT

The present invention discloses a coil part including: a first coil body including a first magnetic substrate, a first coil pattern provided on the first magnetic substrate, and a first insulating layer covering the first coil pattern; a second coil body including a second magnetic substrate corresponding to the first magnetic substrate, a second coil pattern provided on the second magnetic substrate to correspond to the first coil pattern, and a second insulating layer covering the second coil pattern; and a ferrite composite interposed between the first insulating layer and the second insulating layer to couple the first coil body and the second coil body and having a spacer ball inside.

According to the present invention, it is possible to prevent process defects generated during a manufacturing process of an existing coil part using a ferrite substrate, improve process efficiency and productivity, and reduce manufacturing costs.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2011-0140413, entitled filed Dec. 22, 2011, which is hereby incorporated by reference in its entirety into this application.

### BACKGROUND OF THE INVENTION

1. Field of the Invention

The present invention relates to coil parts, and more particularly, to coil parts capable of improving matching between coil patterns and increasing horizontal flatness.

2. Description of the Related Art

Electronic products, such as digital TVs, smart phones, and notebook computers, have functions for data communication in radio-frequency bands. Such IT electronic products are expected to be more widely used since they have multifunctional and complex features by connecting not only one device but also USBs and other communication ports.

Here, for higher-speed data communication, data are communicated through more internal signal lines by moving from MHz frequency bands to GHz radio-frequency bands.

When more data are communicated between a main device and a peripheral device over a GHz radio-frequency band, it is difficult to provide smooth data processing due to a signal delay and other noises.

In order to solve the above problem, an EMI prevention part is provided around the connection between an IT device and a peripheral device. However, conventional EMI prevention parts are used only in limited regions such as specific portions and large-area substrates since they are coil-type and stack-type and have large chip part sizes and poor electrical characteristics. Therefore, there is a need for EMI prevention parts that are suitable for slim, miniaturized, complex, and multifunctional features of electronic products.

A common-mode filter of EMI prevention coil parts in accordance with the prior art is described below in detail with reference to FIG. 1.

Referring to FIG. 1, a conventional common-mode filter includes a first magnetic substrate 1, an insulating layer 2 provided on the magnetic substrate 1 and including a first coil pattern 2a and a second coil pattern 2b that are vertically symmetrical to each other, and a second magnetic substrate 3 provided on the insulating layer 2.

Here, the insulating layer 2 including the first coil pattern 2a and the second coil pattern 2b is formed on the first magnetic substrate 1 through a thin-film process. An example of the thin-film process is disclosed in Japanese Patent Application Laid-Open No. 8-203737.

And, the second magnetic substrate 3 is bonded to the insulating layer 2 through an adhesive layer 4.

Further, an external electrode 5 is provided to surround both ends of a laminate including the first magnetic substrate 1, the insulating layer 2, and the second magnetic substrate 3. The external electrode 5 is electrically connected to the first coil pattern 2a and the second coil pattern 2b through a lead line (not shown).

Meanwhile, the insulating layer 2 consists of a first insulating layer including the first coil pattern 2a and a second insulating layer including the second coil pattern 2b.

That is, the first insulating layer including the first coil pattern 2a is formed by coating an insulating material after forming the first coil pattern 2a on an upper surface of the first magnetic substrate 1 through a thin-film process including a photo process and an exposure process. The second insulating layer including the second coil pattern 2b is formed by coating an insulating material after forming the second coil pattern 2b on an upper surface of the first insulating layer through a thin-film process including a photo process and an exposure process.

However, the conventional common-mode filter configured as above has difficulty in securing flatness of the upper surface of the first insulating layer. Accordingly, poor matching and alignment between the first coil pattern 2a and the second coil pattern 2b are caused by the poor flatness of the upper surface of the first insulating layer, thus causing poor matching and alignment between the first magnetic substrate 1 and the second magnetic substrate 3. Ultimately, due to this problem, impedance characteristics of the common-mode filter are deteriorated, thus causing degradation of performance and reliability of the common-mode filter.

### SUMMARY OF THE INVENTION

The present invention has been invented in order to overcome the above-described problems and it is, therefore, an object of the present invention to provide a coil part capable of improving matching between a first coil pattern and a second coil pattern, and a method of manufacturing the same.

It is another object of the present invention to provide a coil part capable of improving characteristics and performance by easily forming a magnetic material in a center of a first coil pattern and a center of a second coil pattern, and a method of manufacturing the same.

It is still another object of the present invention to provide a coil part capable of improving horizontal flatness when coupling a first coil body and a second coil body, and a method of manufacturing the same.

In accordance with one aspect of the present invention to achieve the object, there is provided a coil part including: a first coil body including a first magnetic substrate, a first coil pattern provided on the first magnetic substrate, and a first insulating layer covering the first coil pattern; a second coil body including a second magnetic substrate corresponding to the first magnetic substrate, a second coil pattern provided on the second magnetic substrate to correspond to the first coil pattern, and a second insulating layer covering the second coil pattern; and a ferrite composite interposed between the first insulating layer and the second insulating layer to couple the first coil body and the second coil body and having a spacer ball inside.

Here, a first alignment hole may be formed in the first magnetic substrate, and a second alignment hole corresponding to the first alignment hole may be formed in the second magnetic substrate. Accordingly, the first coil body and the second coil body may be coupled by the ferrite composite in a state of being aligned through the first alignment hole and the second alignment hole.

At this time, each of the first magnetic substrate and the second magnetic substrate may be formed with a size of 4 to 8 inches and a thickness of 0.2 to 1 mm.

Further, each of the first magnetic substrate and the second magnetic substrate may be made of a ferrite magnetic material.

Meanwhile, the spacer ball may be made of one of mesophase of liquid crystal, ceramic, and metal.

On the other hand, the ferrite composite may include ferrite powder and resin.

Here, the resin may include adhesive epoxy or polymer.

And, the spacer ball may be formed larger than a size of the ferrite powder.

Meanwhile, a first cavity and a second cavity may be formed in a center of the first insulating layer and a center of the second insulating layer, respectively, and the ferrite composite may be embedded in the first cavity and the second cavity.

In accordance with another aspect of the present invention to achieve the object, there is provided a method of manufacturing a coil part including the steps of: preparing a first coil body including a first magnetic substrate, a first coil pattern provided on the first magnetic substrate, and a first insulating layer covering the first coil pattern; preparing a second coil body including a second magnetic substrate corresponding to the first magnetic substrate, a second coil pattern provided on the second magnetic substrate to correspond to the first coil pattern, and a second insulating layer covering the second coil pattern; and coupling the first coil body and the second coil body by interposing a ferrite composite, which has a spacer ball inside, between the first insulating layer and the second insulating layer.

The step of coupling the first coil body and the second coil body may include the step of aligning the first magnetic substrate and the second magnetic substrate by detecting a first alignment hole formed in the first magnetic substrate and a second alignment hole formed in the second magnetic substrate.

And, each of the first magnetic substrate and the second magnetic substrate may be formed with a size of 4 to 8 inches and a thickness of 0.2 to 1 mm.

Further, each of the first magnetic substrate and the second magnetic substrate may be made of a ferrite magnetic material.

Meanwhile, the spacer ball may be made of one of mesophase of liquid crystal, ceramic, and metal.

On the other hand, the ferrite composite may include ferrite powder and resin.

Here, the resin may include adhesive epoxy or polymer.

And, the spacer ball may be formed larger than a size of the ferrite powder.

Meanwhile, a first cavity may be formed in a center of the first insulating layer of the first coil body, and a second cavity may be formed in a center of the second insulating layer of the second coil body. Accordingly, in the step of coupling the first coil body and the second coil body, the ferrite composite may be embedded in the first cavity and the second cavity.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view schematically showing a common-mode filter of coil parts in accordance with the prior art;

FIG. 2 is a cross-sectional view schematically showing a first embodiment of a coil part in accordance with the present invention;

FIGS. 3 to 6 are process cross-sectional views schematically showing a first embodiment of a method of manufacturing a coil part in accordance with the present invention;

FIG. 7 is a cross-sectional view schematically showing a second embodiment of a coil part in accordance with the present invention; and

FIGS. 8 to 11 are process cross-sectional views schematically showing a second embodiment of a method of manufacturing a coil part in accordance with the present invention.

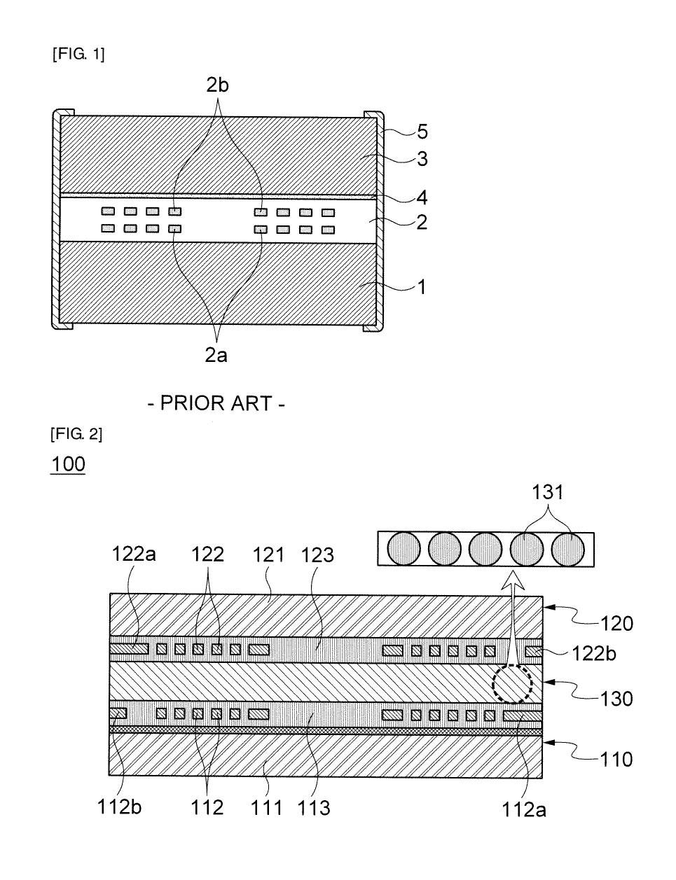

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The exemplary embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Further, embodiments to be described throughout the specification will be described with reference to cross-sectional views and/or plan views, which are ideal exemplary drawings of the present invention. In the drawings, the thicknesses of layers and regions may be exaggerated for the effective explanation of technical contents. Therefore, the exemplary drawings may be modified by manufacturing techniques and/or tolerances. Therefore, the embodiments of the present invention are not limited to the accompanying drawings, and can include modifications to be generated according to manufacturing processes. For example, an etched region shown at a right angle may be formed in the rounded shape or formed to have a predetermined curvature. Therefore, regions shown in the drawings have schematic characteristics. In addition, the shapes of the regions shown in the drawings exemplify specific shapes of regions in an element, and do not limit the invention.

Hereinafter, preferred embodiments of a coil part and a method of manufacturing the same in accordance with the present invention will be described in detail with reference to FIGS. 2 to 11.

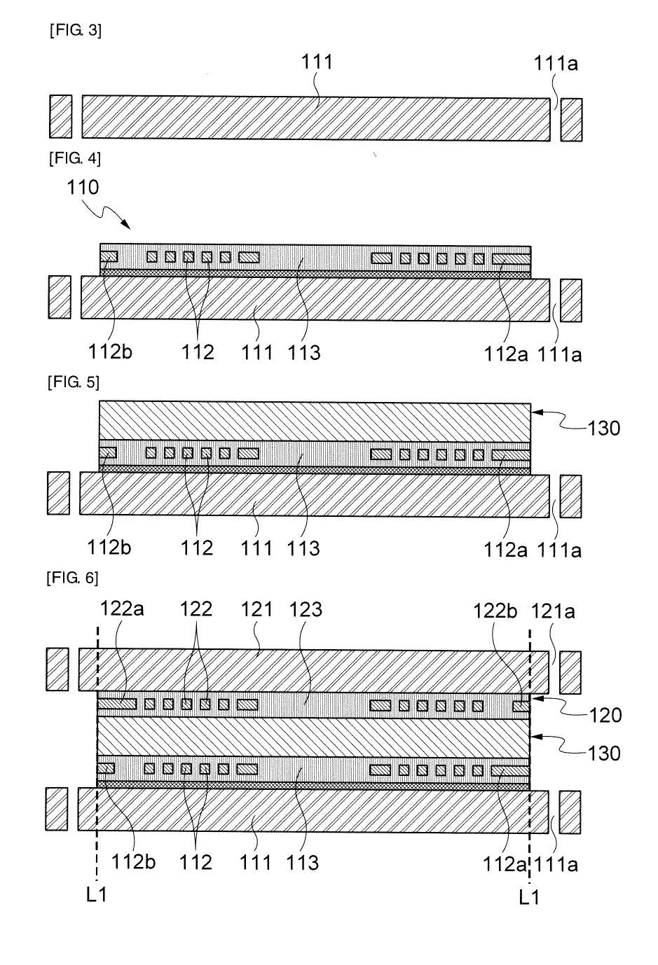

FIG. 2 is a cross-sectional view schematically showing a first embodiment of a coil part in accordance with the present invention, and FIGS. 3 to 6 are process cross-sectional views schematically showing a first embodiment of a method of manufacturing a coil part in accordance with the present invention.

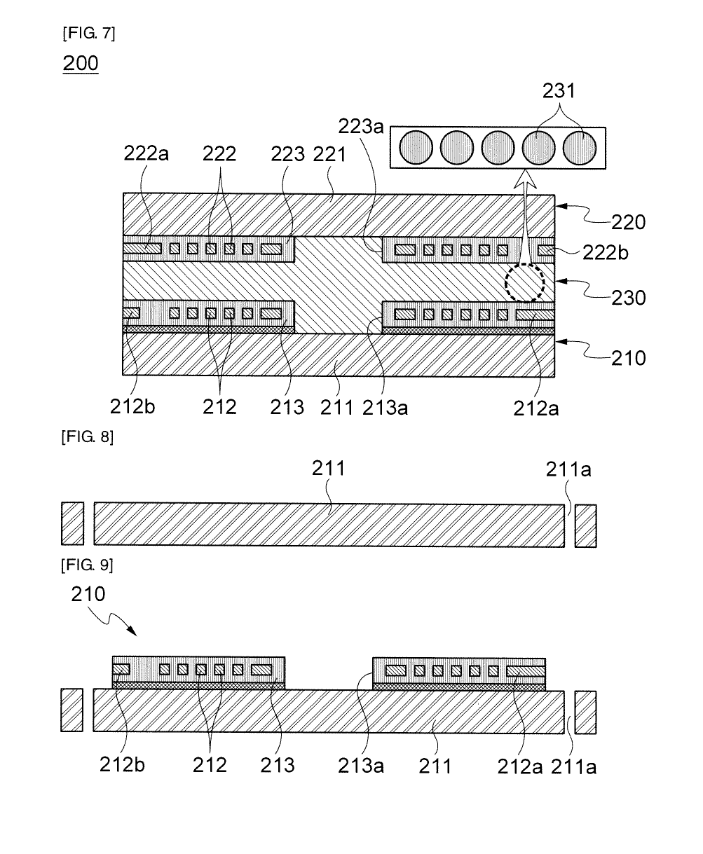

And, FIG. 7 is a cross-sectional view schematically showing a second embodiment of a coil part in accordance with the present invention, and FIGS. 8 to 11 are process cross-sectional views schematically showing a second embodiment of a method of manufacturing a coil part in accordance with the present invention.

A first embodiment of a coil part and a method of manufacturing the same in accordance with the present invention will be described with reference to FIGS. 2 to 6.

Referring to FIG. 2, a first embodiment 100 of a coil part in accordance with the present invention may include a first coil body 110, a second coil body 120, and a ferrite composite 130 interposed between the first coil body 110 and the second coil body 120 to couple the first coil body 110 and the second coil body 120.

The first coil body 110 may include a first magnetic substrate 111, a first coil pattern 112 provided on the first magnetic substrate 111, and a first insulating layer 113 covering the first coil pattern 112.

The second coil body 120 may include a second magnetic substrate 121 corresponding to the first magnetic substrate 111, a second coil pattern 122 provided on the second magnetic substrate 121 to correspond to the first coil pattern 112, and a second insulating layer 123 covering the second coil pattern 122.

Here, a first alignment hole (refer to 111a of FIG. 6) may be formed in the first magnetic substrate 111, and a second alignment hole (refer to 121a of FIG. 6) corresponding to the first alignment hole (refer to 111a of FIG. 6) may be formed in the second magnetic substrate 121. Accordingly, the first coil body 110 and the second coil body 120 may be coupled by the ferrite composite 130 in a state of being aligned by detection of the first alignment hole 111a and the second alignment hole 121a.

Therefore, it is possible to secure exact matching and alignment between the first coil pattern 112 and the second coil pattern 122 and between the first magnetic substrate 111 and the second magnetic substrate 112.

At this time, the coil part 100 of this embodiment can be commercialized by cutting both ends of the first magnetic substrate 111 and the second magnetic substrate 121 along dicing lines (refer to L1 of FIG. 6) after the first coil body 110 and the second coil body 120 are coupled by the ferrite composite 130.

And, each of the first magnetic substrate 111 and the second magnetic substrate 121 may be formed with a size of 4 to 8 inches and a thickness of 0.2 to 1 mm.

As an example, each of the first magnetic substrate 111 and the second magnetic substrate 121 may be formed in the shape of a square plate with a size of 40 mm wide and 40 mm long on the plane and a thickness of 0.25 mm.

Further, each of the first magnetic substrate 111 and the second magnetic substrate 121 may be made of a ferrite magnetic material.

Meanwhile, the ferrite composite 130 may include ferrite powder and resin and have a spacer ball 131 inside.

Here, the resin may include adhesive epoxy or polymer.

And, the spacer ball may be made of one of mesophase of liquid crystal, ceramic, and metal.

At this time, the spacer ball may be formed larger than a size of the ferrite powder.

Accordingly, when coupling the first coil body 110 and the second coil body 120 using the ferrite composite 130, as the spacer ball 131 uniformly maintains the interval between the first insulating layer 113 and the second insulating layer 123 along a horizontal direction, it is possible to improve horizontal flatness between the first coil body 110 and the second coil body 120.

In a method of manufacturing the coil part 100 of this embodiment configured as above, as shown in FIG. 3, a first magnetic substrate 111 having first alignment holes 111a at both ends is prepared.

Next, as shown in FIG. 4, a first coil pattern 112 is formed in a spiral shape on an upper surface of the first magnetic substrate 111 through a thin-film process, and the first coil pattern 112 is covered with a first insulating layer 113.

Here, an input lead pattern 112a and an output lead pattern 112b for input and output of electricity of the first coil pattern 112 may be formed on the first insulating layer 113.

At this time, the input lead pattern 112a may be formed in an outer end portion of the first coil pattern 112, and the output lead pattern 112b may be electrically connected to an inner end portion of the first coil pattern 112.

Next, as shown in FIG. 5, a ferrite composite 130 is laminated on an upper surface of the first insulating layer 113.

After that, as shown in FIG. 6, a second coil body 120 manufactured with the same structure and method as the first coil body 110 is laminated on an upper surface of the ferrite composite 130 to couple the first coil body 110 and the second coil body 120 by the ferrite composite 130.

At this time, the second insulating layer 123 of the second coil body 120 may face the first insulating layer 113 by the ferrite composite 130, and a spacer ball (refer to 131 of FIG. 2) may be included inside the ferrite composite 130.

And, after coupling the first coil body 110 and the second coil body 120 by the ferrite composite 130, it is possible to commercialize the coil part of this embodiment by cutting both ends of the first magnetic substrate 111 and both ends of a second magnetic substrate 121 along dicing lines L1.

Next, a second embodiment of a coil part and a method of manufacturing the same will be described with reference to FIGS. 7 to 11.

Referring to FIG. 7, a second embodiment 200 of a coil part in accordance with the present invention may include a first coil body 210, a second coil body 220, and a ferrite composite 230 interposed between the first coil body 210 and the second coil body 220 to couple the first coil body 210 and the second coil body 220.

The first coil body 210 may include a first magnetic substrate 211, a first coil pattern 212 provided on the first magnetic substrate 211, and a first insulating layer 213 covering the first coil pattern 212.

The second coil body 220 may include a second magnetic substrate 221 corresponding to the first magnetic substrate 211, a second coil pattern 222 provided on the second magnetic substrate 221 to correspond to the first coil pattern 212, and a second insulating layer 223 covering the second coil pattern 222.

Meanwhile, in the coil part 200 in accordance with this embodiment, unlike the above-described first embodiment, a first cavity 213a and a second cavity 223a may be formed in a center of the first insulating layer 213 and a center of the second insulating layer 223, respectively.

Accordingly, in this embodiment, the ferrite composite 230 may be embedded in the first cavity 213a and the second cavity 223a when coupling the first coil body 210 and the second coil body 220.

Meanwhile, a first alignment hole (refer to 211a of FIG. 11) may be formed in the first magnetic substrate 211, and a second alignment hole (refer to 221a FIG. 11) corresponding to the first alignment hole (refer to 211a of FIG. 11) may be formed in the second magnetic substrate 221. Accordingly, the first coil body 210 and the second coil body 220 may be coupled by the ferrite composite 230 in a state of being aligned by detection of the first alignment hole 211a and the second alignment hole 221a.

Therefore, it is possible to secure exact matching and alignment between the first coil pattern 212 and the second coil pattern 222 and between the first magnetic substrate 211 and the second magnetic substrate 221.

At this time, the coil part 200 of this embodiment can be commercialized by cutting both ends of the first magnetic substrate 211 and the second magnetic substrate 221 along dicing lines (refer to L2 of FIG. 11) after the first coil body 210 and the second coil body 220 are coupled by the ferrite composite 230.

And, each of the first magnetic substrate 211 and the second magnetic substrate 221 may be formed with a size of 4 to 8 inches and a thickness of 0.2 to 1 mm.

As an example, each of the first magnetic substrate 211 and the second magnetic substrate 221 may be formed in the shape of a square plate with a size of 40 mm wide and 40 mm long on the plane and a thickness of 0.25 mm.

Further, each of the first magnetic substrate 211 and the second magnetic substrate 221 may be made of a ferrite magnetic material.

Meanwhile, the ferrite composite 230 may include ferrite powder and resin and have a spacer ball 231 inside.

Here, the resin may include adhesive epoxy or polymer.

And, the spacer ball 231 may be made of one of mesophase of liquid crystal, ceramic, and metal.

At this time, the spacer ball 231 may be formed larger than a size of the ferrite powder.

Accordingly, when coupling the first coil body 210 and the second coil body 220 using the ferrite composite 230, as the spacer ball 231 uniformly maintains the interval between the first insulating layer 213 and the second insulating layer 223 along a horizontal direction, it is possible to improve horizontal flatness between the first coil body 210 and the second coil body 220.

In a method of manufacturing the coil part 200 of this embodiment configured as above, as shown in FIG. 8, a first magnetic substrate 211 having first alignment holes 211a at both ends is prepared.

Next, as shown in FIG. 9, a first coil pattern 212 is formed in a spiral shape on an upper surface of the first magnetic substrate 211 through a thin-film process, and the first coil pattern 212 is covered with a first insulating layer 213.

Here, an input lead pattern 212a and an output lead pattern 212b for input and output of electricity of the first coil pattern 212 may be formed on the first insulating layer 213.

At this time, the input lead pattern 212a may be formed in an outer end portion of the first coil pattern 212, and the output lead pattern 212b may be electrically connected to an inner end portion of the first coil pattern 212.

And, a first cavity 213a and a second cavity 223a are formed in a center of the first insulating layer 213 and a center of a second insulating layer 223, respectively.

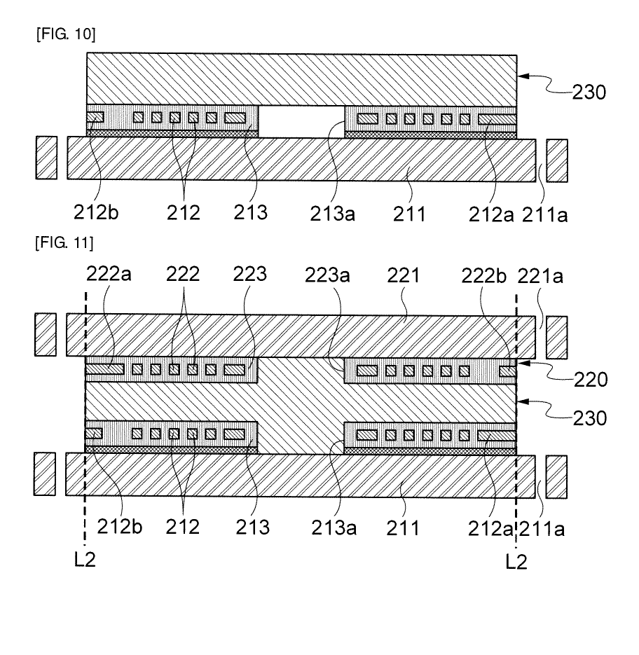

Next, as shown in FIG. 10, a ferrite composite 230 is laminated on an upper surface of the first insulating layer 213.

After that, as shown in FIG. 11, a second coil body 220 manufactured with the same structure and method as the first coil body 210 is laminated on an upper surface of the ferrite composite 230 to couple the first coil body 210 and the second coil body 220 by the ferrite composite 230.

At this time, the second insulating layer 223 of the second coil body 220 may face the first insulating layer 213 by the ferrite composite 230. Accordingly, the ferrite composite 230 may be embedded in the first cavity 213a and the second cavity 223a by a coupling force of the first coil body 210 and the second coil body 220.

Here, the ferrite composite 230 may be formed in a gel state to be easily embedded in the first cavity 213a and the second cavity 223a, and a spacer ball (refer to 231 of FIG. 7) may be included inside the ferrite composite 230.

And, after coupling the first coil body 210 and the second coil body 220 by the ferrite composite 230, it is possible to commercialize the coil part of this embodiment by cutting both ends of the first magnetic substrate 211 and both ends of the second magnetic substrates 221 along dicing lines L2.

As described above, according to the coil part and the method of manufacturing the same in accordance with the present invention, it is possible to improve matching between a first coil pattern and a second coil pattern by bonding a first coil body and a second coil body using a ferrite composite including a spacer ball.

And, according to the coil part and the method of manufacturing the same in accordance with the present invention, it is possible to improve characteristics and performance of a coil part by embedding a ferrite composite in a center of a first coil pattern and a center of a second coil pattern to smoothly increase a flow of magnetic flux.

Further, according to the coil part and the method of manufacturing the same in accordance with the present invention, it is possible to improve impedance characteristics and thus improve performance of a coil part due to exact alignment between coil patterns by increasing horizontal flatness when coupling a first coil body and a second coil body.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

What is claimed is:

1. A coil part comprising:
a first coil body including a first magnetic substrate, a first coil pattern provided on the first magnetic substrate, and a first insulating layer covering the first coil pattern;
a second coil body including a second magnetic substrate corresponding to the first magnetic substrate, a second coil pattern provided on the second magnetic substrate to correspond to the first coil pattern, and a second insulating layer covering the second coil pattern; and
a ferrite composite interposed between the first insulating layer and the second insulating layer to couple the first coil body and the second coil body and having a spacer ball inside.

2. The coil part according to claim 1, wherein a first alignment hole is formed in the first magnetic substrate and a second alignment hole corresponding to the first alignment hole is formed in the second magnetic substrate so that the first coil body and the second coil body are coupled by the ferrite composite in a state of being aligned through the first alignment hole and the second alignment hole.

3. The coil part according to claim 1, wherein each of the first magnetic substrate and the second magnetic substrate is formed with a size of 4 to 8 inches and a thickness of 0.2 to 1 mm.

4. The coil part according to claim 1, wherein each of the first magnetic substrate and the second magnetic substrate is made of a ferrite magnetic material.

5. The coil part according to claim 1, wherein the spacer ball is made of one of mesophase of liquid crystal, ceramic, and metal.

6. The coil part according to claim 1, wherein the ferrite composite comprises ferrite powder and resin.

7. The coil part according to claim 6, wherein the resin comprises adhesive epoxy or polymer.

8. The coil part according to claim 6, wherein the spacer ball is formed larger than a size of the ferrite powder.

9. The coil part according to claim 1, wherein a first cavity and a second cavity are formed in a center of the first insulating layer and a center of the second insulating layer, respectively, and the ferrite composite is embedded in the first cavity and the second cavity.

10. A method of manufacturing a coil part comprising:
preparing a first coil body including a first magnetic substrate, a first coil pattern provided on the first magnetic substrate, and a first insulating layer covering the first coil pattern;
preparing a second coil body including a second magnetic substrate corresponding to the first magnetic substrate, a second coil pattern provided on the second magnetic substrate to correspond to the first coil pattern, and a second insulating layer covering the second coil pattern; and
coupling the first coil body and the second coil body by interposing a ferrite composite, which has a spacer ball inside, between the first insulating layer and the second insulating layer.

11. The method of manufacturing a coil part according to claim 10, wherein coupling the first coil body and the second coil body comprises aligning the first magnetic substrate and the second magnetic substrate by detecting a first alignment hole formed in the first magnetic substrate and a second alignment hole formed in the second magnetic substrate.

12. The method of manufacturing a coil part according to claim 10, wherein each of the first magnetic substrate and the second magnetic substrate is formed with a size of 4 to 8 inches and a thickness of 0.2 to 1 mm.

13. The method of manufacturing a coil part according to claim 10, wherein each of the first magnetic substrate and the second magnetic substrate is made of a ferrite magnetic material.

14. The method of manufacturing a coil part according to claim 10, wherein the spacer ball is made of one of mesophase of liquid crystal, ceramic, and metal.

15. The method of manufacturing a coil part according to claim 10, wherein the ferrite composite comprises ferrite powder and resin.

16. The method of manufacturing a coil part according to claim 15, wherein the resin comprises adhesive epoxy or polymer.

17. The method of manufacturing a coil part according to claim 15, wherein the spacer ball is formed larger than a size of the ferrite powder.

18. The method of manufacturing a coil part according to claim 10, wherein
a first cavity is formed in a center of the first insulating layer of the first coil body and a second cavity is formed in a center of the second insulating layer of the second coil body; and
in coupling the first coil body and the second coil body, the ferrite composite is embedded in the first cavity and the second cavity.
